(19) United States
(12) Patent Application Publication
(10) Pub. No.: US 2022/0397407 A1
(43) Pub. Date: Dec. 15, 2022

(54) REFUELING VEHICLE ROUTING SYSTEM

(71) Applicant: Booster Fuels, Inc., San Mateo, CA (US)

(72) Inventors: Chenyin Ge, Walnut Creek, CA (US); John Carlsson, Milpitas, CA (US); John Paul Tokash, Pacifica, CA (US); Paul Teyssier, Belmont, CA (US)

(73) Assignee: Booster Fuels, Inc.

(21) Appl. No.: 17/344,767

(22) Filed: Jun. 10, 2021

(51) Int. Cl. G01C 21/34; G06Q 10/08; G01C 21/36

(52) U.S. Cl. CPC G01C 21/3469; G06Q 10/08355; G01C 21/3446; G01C 21/3667

(57) ABSTRACT

The refueling vehicle routing system can use a refueling vehicle routing application to compute a set of fuel delivery routes for a fleet of refueling vehicles for multiple different target vehicles to be serviced via cooperating with a refueling scenario simulator. The refueling scenario simulator can run scenarios of different sets of refueling routes to refuel target vehicles in light of an available set of assets, and then the application can supply results of how the versions of the set of refueling routes for the fleet of refueling vehicles are going to satisfy anticipated refueling needs for the target vehicles; to indicate any refueling stops that could be late, early, and/or missed entirely, for a service window of time; as well as to show a measure of how cost effective each of the refueling routes are at the satisfying of the needs for the target vehicles.

### TECHNICAL FIELD

Embodiments of this disclosure relate generally to vehicle routing.

### BACKGROUND

Individual consumers purchase gasoline for their vehicle at a gas station. Large companies can own a large fleet of vehicles can have fuel tanks onsite to refuel their vehicles but must pay their employees to refill all of their vehicles and deal with all of the requirements storing and dispensing that fuel. There are typically many middlemen and inefficient mechanisms in the process of producing fuel at a refinery to putting that fuel in a vehicle's fuel tank.

What is needed is a system that allows individual consumers and large companies to purchase vehicle fuel on-line, on a mobile app, and in other ways to have a refueling vehicle to drive to where their vehicle is parked and fill up the fuel tank of that vehicle.

### SUMMARY

Provided herein are various methods, apparatuses, and systems for a refueling vehicle routing system.

A refueling vehicle routing system can include servers, databases, various modules, a fleet of refueling vehicles with wireless gateways, a refueling vehicle routing application, and a refueling scenario simulator. The refueling vehicle routing system can use a communication module to receive and send communications over a cloud network and then to multiple refueling vehicles wirelessly connected to the cloud network.

The refueling vehicle routing application computes a set of fuel delivery routes for the fleet of two or more refueling vehicles for multiple different target vehicles to be serviced via cooperating with a refueling scenario simulator. The refueling scenario simulator is configured to run at least a hundred scenarios of different sets of refueling routes to refuel known target vehicles in light of an available set of assets. The refueling vehicle routing application can collect and analyze data and outputs from the refueling scenario simulator. The refueling vehicle routing application can supply results of how two or more versions of the set of refueling routes for the fleet of refueling vehicles are going 1) to satisfy anticipated refueling needs for all known target vehicles; 2) to indicate any refueling stops that are likely to be, at least one of, i) late, ii) early, iii) missed entirely, and iv) any of these three, for a window of time in which that refueling stop should be serviced; as well as 3) to show a measure of how cost effective each of the two or more versions of the set of refueling routes is at the satisfying of the anticipated refueling needs for all of the known target vehicles.

An input module can have software and input/output ports to take in a plurality of constraints and parameters as factors for the refueling vehicle routing application to assist in producing the results of how two or more versions of the set of refueling routes for the fleet of refueling vehicles are going 1) to satisfy the anticipated refueling needs for all of the known target vehicles; 2) to indicate the refueling stops that are likely to be, at least one of, i) late, ii) early, iii) missed entirely, and iv) any of these three, for the window of time in which that refueling stop should be serviced; as well as 3) to show the measure of how cost effective each of the two or more versions of the set of refueling routes is at the satisfying of the anticipated refueling needs for all of the known target vehicles.

These and many more embodiments are discussed.

### DRAWINGS

FIG. 1 illustrates a block diagram of an embodiment of an example refueling vehicle routing system that includes a refueling vehicle routing application that computes a set of fuel delivery routes for a fleet of two or more refueling vehicles for multiple different target vehicles to be serviced that day/work shift via cooperating with a refueling scenario simulator.

FIG. 2 illustrates a block diagram of an embodiment of an example refueling vehicle routing system that has a refueling vehicle routing application operating on one or more servers and databases.

FIG. 3 illustrates a block diagram of an embodiment of an example refueling vehicle routing application performing vehicle routing that factors in constraints and parameters to utilize a combined amount of available assets located in multiple fuel depot yards to service a set of refueling routes for known vehicles in, at least, a first region.

FIG. 4 illustrates a block diagram of an embodiment of an example user interface module configured to present the indications for the two or more versions of the set of refueling routes for the fleet of refueling vehicles to one or more users on one or more display screens.

FIG. 5 illustrates a block diagram of an embodiment of an example output module configured to publish on the cloud as well as locally present on a display screen a version of the set of refueling routes to one or more users.

FIG. 6 illustrates a block diagram of an embodiment of an example set of refueling routes generated and presented by the user interface module to one or more users.

FIG. 7 illustrates a block diagram of an embodiment of an example output results, from the refueling vehicle routing application via the user interface module, of a set of refueling routes, in a table format.

FIG. 8 illustrates a diagram of an embodiment of one or more computing devices that can be a part of the systems associated with the refueling vehicle routing system discussed herein.

While the design is subject to various modifications, equivalents, and alternative forms, specific embodiments thereof have been shown by way of example in the drawings and will now be described in detail. It should be understood that the design is not limited to the particular embodiments disclosed, but—on the contrary—the intention is to cover all modifications, equivalents, and alternative forms using the specific embodiments.

### DESCRIPTION

In the following description, numerous specific details can be set forth, such as examples of specific data signals, named components, number of frames, etc., in order to provide a thorough understanding of the present design. It will be apparent, however, to one of ordinary skill in the art that the present design can be practiced without these specific details. In other instances, well known components or methods have not been described in detail but rather in a block diagram in order to avoid unnecessarily obscuring the present design. Further, specific numeric references such as the first server, can be made. However, the specific numeric reference should not be interpreted as a literal sequential order but rather interpreted that the first server is different than a second server. Thus, the specific details set forth can be merely exemplary. The specific details can be varied from and still be contemplated to be within the spirit and scope of the present design. The term “coupled” is defined as meaning connected either directly to the component or indirectly to the component through another component.

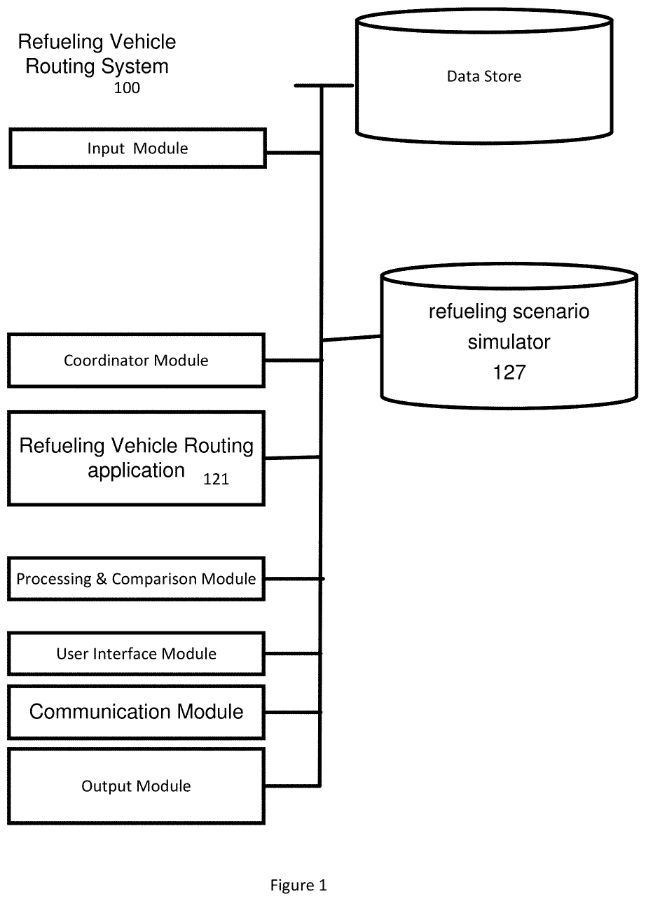

FIG. 1 illustrates a block diagram of an embodiment of an example refueling vehicle routing system that includes a refueling vehicle routing application that computes a set of fuel delivery routes for a fleet of two or more refueling vehicles for multiple different target vehicles to be serviced that day/work shift via cooperating with a refueling scenario simulator. The refueling scenario simulator 127, such as a solver, can be coded to run at least a hundred scenarios of different sets of refueling routes to refuel known target vehicles in light of an available set of assets, and up to millions of scenarios factoring X amount of different sets of refueling routes including possible roadways to refuel Y amount of known target vehicles and their variable parameters, in light of Z amount of currently available set of assets, in light of a cost effectiveness analysis and its variable parameters, in light of time of day and time in a work shift, in light of W amount of constraints placed on the refueling operations, in light of any other relevant factors. The amount of scenarios is dependent on how many variables are in the parameters and constraints associated with each of above factors. After the scenarios are run, the refueling vehicle routing application 121 can collect and store the results from each of the scenarios. The refueling vehicle routing application 121 is coded to then generate results of how two or more versions of the set of refueling routes for the fleet of refueling vehicles are going 1) to satisfy anticipated refueling needs for all of the known target vehicles, 2) to indicate any refueling stops that could be at risk (e.g., >66% chance) of being, at least one of, i) late, ii) early, iii) missed entirely, and iv) any of these three, for a window of time in which that refueling stop should be serviced, as well as 3) to show a measure of how cost effective each version of the set of refueling routes is in the satisfying of the anticipated refueling needs for all of the known target vehicles; so that a user, such as a shift supervisor, can evaluate top ranked versions of the set of refueling routes and use local knowledge and other factors to choose a best set of refueling routes for the fleet of refueling vehicles to use. Many of the constraints and parameters are pulled from stored information from a datastore and other applications while some information subject to rapid change can be dynamically pulled or pushed the through the I-O ports and input module. For example, a road mapping program, the finance application, the scheduling application, all are coded to interface with the refueling vehicle routing application 121 to supply static information as well as the information subject to rapidly changing. Most of these constraints and parameters are based on, at least, heuristics of customers such as 1) each of the target vehicles' make, model, Vehicle Identification Number, License Plate, etc., 2) average, projected, and/or a maximum amount of fuel a target vehicle is refueled during a refueling stop, 3) contracted refueling rates for that customer, 4) any constraints of when a specific window of time exists in which a given refueling stop should be serviced for a set of known target vehicles for that customer, 5) and many other parameters and constraints discussed herein.

An embodiment of the refueling vehicle routing system 100 has various modules including an input module, a coordinator module, a processing and comparison module, a user interface module, a communication module, a refueling vehicle routing application 121, input and output ports, a refueling scenario simulator 127, and a data store, which are all configured to cooperate and communicate with each other to provide the functionality discussed herein.

The input module has one or more Application Programming Interfaces (APIs) to other applications, such as the scheduling application, the finance application, etc., configured to request and/or have pushed in a plurality of constraints and parameters as factors, for the refueling vehicle routing application 121 and the refueling scenario simulator 127.

The refueling vehicle routing application 121 is configured to perform vehicle routing that factors in constraints and parameters. Some additional constraints and parameters include the following.

The refueling vehicle routing application 121 can factor in aspects of a refueling vehicle beyond just a capacity of its fuel tank and its fuel type such as whether the refueling vehicle has multiple tanks (e.g. one common tank with multiple separate compartments within that tank and/or two separate tank); and thus, dispense and refuel two more different types of fuel at each fuel stop. The refueling vehicle with multiple tanks has an ability to haul multiple types of fuels. The refueling vehicle routing application 121 can dynamically determine what a current amount of fuel is in each fuel tank via receiving up link communications at regular intervals from the communication module located in the cab of a refueling vehicle on obtaining that information from a computing system in the cab of a refueling vehicle. The computing system can receive a current amount of fuel tank left in the tank of the refueling vehicle via a level sensor in that tank, which conveys the tank's fuel level to the computing system. In another example, the exact GPS location of the refueling vehicle can be known throughout a work shift to make informed decisions on whether to assign new fuel stops due to a new request, or bad traffic, or equipment failure, etc. The exact current location of a refueling vehicle can be reliably known through use of a GPS tracker onboard the refueling vehicle and a GPS antenna specifically constructed in specific length and electronic filters to receive and expand radio signals sent by distinct frequencies coming from multiple GPS satellites. Different refueling vehicles can have different fuel tank capacity. For example, the different refueling vehicles can have some tanks with a maximum capacity of 3,000 US gallons (11,000 L; 2,500 imp gal), while large tankers have a maximum capacity of 11,600 gallons. Different refueling vehicles can have different fuel pumping systems that load and off-load at different liquid flow rates.

Note, the wireless communication module can include a Wi-Fi gateway, a Blue Tooth module, or other wireless protocol. The wireless communication module can cooperate with a corresponding antenna optimized for the frequencies of that technology.

The refueling vehicle routing application 121 can factor in splitting refueling gallon demand of a refueling site containing multiple target vehicles over multiple refueling vehicles and over multiple refueling routes when an amount of refueling demand (e.g., gallons) for all of the multiple target vehicles located approximate to the refueling site exceed a capacity of a single refueling vehicle. However, each refueling vehicle servicing that one refueling site has had its refueling route optimized as well as the set of refueling routes for all of the refueling vehicles servicing that one refueling site that work shift are optimized. The refueling vehicle routing application 121 can split large accounts such as a fleet customer like a car rental site or package carrier site whose multiple target vehicles exceeds an amount of fuel demand that a single refueling vehicle can provide.

The refueling vehicle routing application 121 can factor in any fuel stop delivery windows that have a fixed time window of when refueling stops must occur in that fixed period of time. Likewise, the refueling vehicle routing application 121 can also review fuel stop delivery windows in the generated set of refueling routes that are likely in danger of being arrived at too early, in danger of being arrived too late to be within the delivery window, and/or in danger of being completely missed because the target vehicle will likely be gone by the time of the fuel delivery. The refueling vehicle routing application 121 can look at time span, start times, stop times, and any fuel delivery windows that fall below a time safety margin or exceed a time safety margin by too much can be flagged as being in danger.

The refueling vehicle routing application 121 and refueling scenario simulator 127 can factor in account prioritization of an importance of one client account compared to another client account. When a window of time for a fuel stop is in danger of being late, early or missed entirely, as discussed above, knowing an identity of the client and an importance of that client account allows a shift supervisor to make an educated decision on whether that fuel stop in danger of being late, early or missed entirely prioritization would be acceptable for a version of the set of refueling routes or not acceptable.

The refueling vehicle routing application 121 and refueling scenario simulator 127 can factor in a combined amount of available assets located in multiple fuel depot yards to service a set of refueling routes for known vehicles in, at least, a first region. The refueling vehicle routing application 121 is not restricted to assets (e.g., refueling vehicles, employees, fuel tanks and fuel types) located within a single fuel depot yard when determining an optimum set of refueling routes for the region typically serviced by one fuel depot yard but can factor in a second fuel depot yard and/or adjacent region's assets when determining what could be an optimum set of refueling routes.

The refueling vehicle routing application 121 and refueling scenario simulator 127 can factor bundling distinct refueling stops for a single customer to be assigned to a same refueling route. For example, a fleet customer can have one or more refueling sites, where each refueling site has multiple target vehicles, but a common key code or physical key is required in order to enter each refueling site. These refueling stops are bundled together.

Next, the refueling vehicle routing application 121 interacts with various modules.

A communication module is configured to receive and send communications over a cloud network and then to multiple refueling vehicles wirelessly connected to the cloud network. Examples of the cloud network can be a Wide Area Network (WAN) or other internet-based network as well as can be a Cellular network.

The user interface module is configured to present the multiple versions of the set of refueling routes to a user on a display screen. The user interface module can present multiple versions of the sets of refueling routes to a user who can select one of the versions of the set of refueling routes to be published on a cloud platform as well as individually communicated via a communications interface to an assigned driver of a refueling vehicle corresponding to their specific refueling route in the set of refueling routes. The user interfaces can also provide a map view, a timeline for a shift view, and a table of refueling routes view.

The refueling vehicle routing application 121 can compute the set of fuel delivery routes for a fleet of two or more refueling vehicles on a daily basis.

An important aspect of the refueling vehicle routing application 121 is its ability to cooperate dynamically in real time with the many systems, including the cooperating applications, the modules, the individual refueling vehicles and their drivers, throughout the work shift to adapt to dynamic changes throughout the day. The refueling vehicle routing application 121 dynamically cooperating with the systems including the refueling vehicles and driver's handheld computing devices can dynamically update the set of refueling routes for that shift when, for example, a new refueling stop needs to be added, a refueling vehicle breakdown, etc. The refueling vehicle routing application 121 dynamically interacts and cooperates with the fleet of two or more refueling vehicles by pushing out updates, for example, on refueling stops and receiving real time data from the refueling vehicles. In this way, on-demand orders for a refueling stop, that were not known when the app was run last and assigned routes, can be added.

The refueling vehicle routing application 121 dynamically interacts and cooperates with the fleet of two or more refueling vehicles. The refueling vehicle routing application 121 does all of this while computing and trying to maintain an efficient and dynamically current set of refueling routes to service all of the target vehicles that shift. The refueling vehicle routing application 121 is configured to cooperate with the communication module and the refueling scenario simulator 127 to be capable of updating the set of refueling routes through the day dynamically, such as every minute. The refueling vehicle routing application 121 can cooperate with the refueling scenario simulator 127, and the user interface module to present selectable options of choosing either 1) a first version of new refueling routes selected in order to minimize an impact on a smallest amount of drivers and their corresponding refueling route as possible or 2) a second version of new refueling routes selected to be the most efficient and cost effective for an entire fleet regardless of how many drivers' refueling routes need to be changed after those drivers have already started servicing the refueling route assigned to them at the beginning of their driving shift.

After dynamically updating refueling route during a work shift, the refueling vehicle routing application 121 is configured to generate a routing notice pushed out through the communication module to convey a refueling route has changed to positively get the driver's attention when a refueling route change occurs from when the driver took the refueling vehicle out for the refueling operations.

The cab of a refueling vehicle has a wireless gateway (transmitter-receiver) to cooperate over a network with the communication module cooperating with the refueling vehicle routing application 121. The wireless gateway in the vehicle can pass information from the cloud to a driver's handheld computing device. Note, the computer in the cab will receive also receive the routing message on an update to the refueling route and then display that message on the display screen in the cab. Note, the wireless network can be Wi-Fi, Blue Tooth, and other wireless protocols and technology.

Next, the refueling vehicle routing application 121 is coded to cooperate with the refueling scenario simulator 127 to provide accurate advanced planning, such as a week's worth or a month's worth of sets of refueling routes, to allow shift supervisors to evaluate anticipated manpower and vehicles needed for each of the upcoming work shifts. In the advanced planning, the refueling vehicle routing application 121 pre-computes each set of fuel delivery routes for a fleet of two or more refueling vehicles, on a per day basis, with estimations of the expected set of fuel delivery routes and corresponding assets needed. The refueling vehicle routing application 121 can collate each day's set of refueling routes into a report spanning a week and/or month showing the refueling routes themselves and the assets needed. The assets needed can include a work force needed e.g., number of drivers, etc., an amount of gallons of each fuel type needed, and an amount of refueling vehicle (e.g., tanker) assets needed.

Advantageously, all of these versions of sets of refueling routes are optimized based on at least known heuristics of customers. The refueling vehicle routing application 121 and refueling scenario simulator 127 produce a rough but fairly accurate estimate of the needs based on historical data and other known factors. The refueling vehicle routing application 121 produces one or more versions of the set of refueling routes for that day which are optimized close to capacity of the needed assets to satisfy fuel demand in the most economical way and determine if any tanker fuel reloads will be needed.

However, the refueling vehicle routing application 121 cannot know the exact amount of fuel needed for that target vehicle during a scheduled refueling stop. Thus, refueling truck has onboard both calibrated meters to obtain an exact amount of fuel put into each target vehicle as well as the level sensors in the tank(s) of the refueling vehicle to provide that dynamic information to the refueling vehicle routing application 121 to provide this dynamic information to allow the refueling vehicle routing application 121 to determine if any adjustments are needed for the set of refueling routes that day/shift. If so, the refueling vehicle routing application 121 will generate a notification to the shift supervisor as well as trigger another set of refueling scenarios with the refueling scenario simulator 127.

The refueling vehicle routing application 121 cooperating with the refueling scenario simulator 127 can evaluate and run potentially millions of scenarios and then generate the results indications (e.g., results) of each scenario. In general, no single output parameter in the results indications for the set of refueling routes can make one version of the set of refueling routes generated by the scenarios better than another set of refueling routes. The parameters of the results such as fuel price, efficiency of gallons per hour, how much overtime for the drivers, time window violations, etc. all convey different information to evaluate. However, an accumulative effect of each parameter of the results can be factored and evaluated by comparing the set of resulting output parameters for each version of the refueling routes.

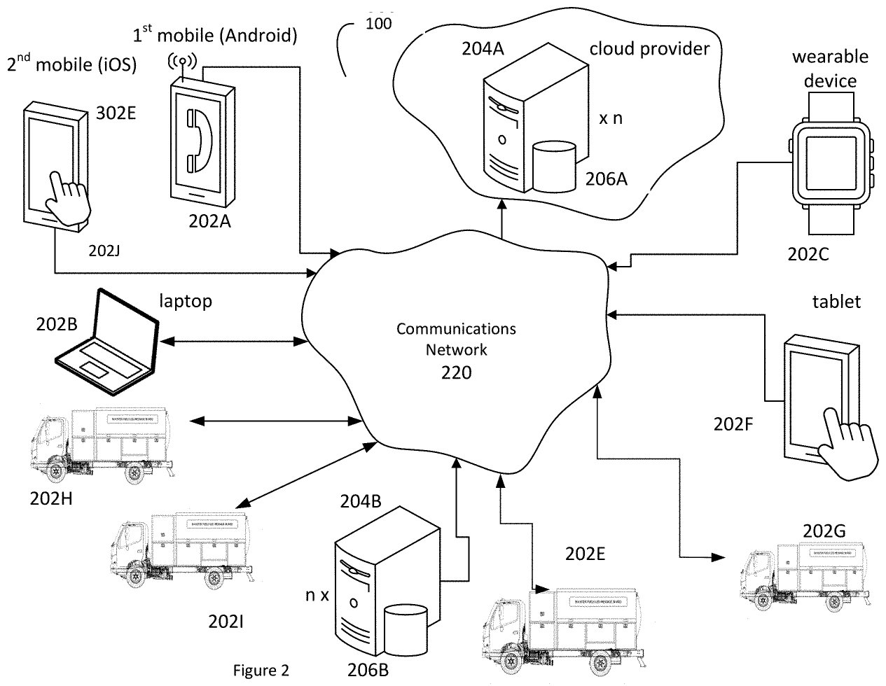

FIG. 2 illustrates a block diagram of an embodiment of an example refueling vehicle routing system that has a refueling vehicle routing application operating on one or more servers and databases. The refueling vehicle routing application 121 uses a communication module to receive and send communications over a cloud network and then to multiple refueling vehicles via both 1) the wireless gateway in the cab of each refueling vehicle as well as 2) a handheld computing device associated with a driver of the associated refueling vehicle, wirelessly connected to the cloud network. Each driver's handheld wireless computing device has its own display, which can display the refueling routes, maps, and other portions of the refueling vehicle routing application 121. The driver's handheld wireless computing device can have a resident app and/or plug-in cooperating with a browser in order to cooperate by securely passing data and instructions with the refueling vehicle routing application 121.

Each corresponding driver has a handheld wireless computing device that has a display to show various information from the refueling vehicle routing application 121. For example, the handheld wireless computing device can show the driver their assigned individual refueling route and its associated refueling stops. The handheld wireless computing device can show the driver their assigned refueling route, which is a filtered view of all of the sets of refueling routes that is filtered for that individual driver. Note, the computing device in the cab of the refueling vehicle is also sent the same filtered view of the refueling route.

As discussed, each refueling vehicle can have a high precision antenna for GPS location tracking, which is an upgrade over GPS from a smart phone. Each refueling vehicle can have an improved Wi-Fi transmitter—receiver and antenna for better communications with the cloud to supply each vehicles' location and feedback on both current inventory fuel level of the tanker as wells as target vehicles (accounts) serviced so that the application can dynamically make more accurate optimal refueling routes for the whole fleet of refueling vehicles. The driver of the refueling vehicle most likely will not just have one fixed refueling route throughout the day even though that's what they were assigned at the beginning of the day. The Multiple assets need to be able to dynamically change the routes when a new refueling stop is ordered that day/on demand, an unexpected long traffic delay occurs, vehicle breakdown, equipment failure, etc. occurs.

The electronic systems and devices can communicate with each other in a network environment 200. The network environment 200 has a communications network 220. The network 220 can include one or more networks selected from an optical network, a cellular network, the Internet, a Local Area Network (“LAN”), a Wide Area Network (“WAN”), a satellite network, a fiber network, a cable network, and combinations thereof. In an embodiment, the communications network 220 is the Internet. As shown, there may be many server computing systems and many client computing systems connected to each other via the communications network 220. However, it should be appreciated that any combination of server computing systems and client computing systems may connect to each other via the communications network 220.

The refueling vehicle routing application 121 can reside and be implemented in this network environment, for example, in the cloud platform of server 204A and database 206A, a local server 204B and database 206B, on a device such as laptop 202D, in a smart system such as smart automobile 202D, and other similar platforms. The refueling vehicle routing application 121 can have portions distributed on multiple devices in this network.

The communications network 220 can connect one or more server computing systems selected from at least a first server computing system 204A and a second server computing system 204B to each other and to at least one or more client computing systems as well. The server computing system 204A can be, for example, the one or more server systems 220. The server computing systems 204A and 204B can each optionally include organized data structures such as databases 206A and 206B. Each of the one or more server computing systems can have one or more virtual server computing systems, and multiple virtual server computing systems can be implemented by design. Each of the one or more server computing systems can have one or more firewalls to protect data integrity.

The at least one or more client computing systems can be selected from a first handheld computing device 202A (e.g., smartphone with an Android-based operating system), a second handheld computing device 202E (e.g., iPad with an iOS-based operating system), a first wearable electronic device 202C (e.g., a smartwatch), a first handheld computer 202B (e.g., laptop computer), a third handheld computing device 202F (e.g., tablet with an Android operating system), a first computing device in a first computing device in a first refueling vehicle 202D, a second computing device in a second refueling vehicle, a third computing device in a third refueling vehicle 202H, a fourth computing device in a fourth refueling vehicle, and the like. Each of the one or more client computing systems can have one or more firewalls to protect data integrity.

It should be appreciated that the use of the terms “client computing system” and “server computing system” is intended to indicate the system that generally initiates a communication and the system that generally responds to the communication. For example, a client computing system can generally initiate a communication and a server computing system generally responds to the communication. Both functions can be in a single communicating system or device, in which case, the client-server and server-client relationship can be viewed as peer-to-peer. Thus, if the first handheld computer 202B (e.g., the client computing system) and the server computing system 204A can both initiate and respond to communications, their communications can be viewed as peer-to-peer.

The refueling vehicle routing application 121 and refueling scenario simulator 127 can use a network like this to supply training data to create, train, and update the refueling scenario simulator 127. For example, the server computing systems 204A and 204B include circuitry and software enabling communication with each other across the network 220. Server 204B may send, for example, simulator data to server 204A.

One or more of the server computing systems can be a cloud provider, such as server 204A. A cloud provider can install and operate application software in a cloud (e.g., the network 220 such as the Internet) and cloud users can access the application software from one or more of the client computing systems. Generally, cloud users that have a cloud-based site in the cloud cannot solely manage a cloud infrastructure or platform where the application software runs. Thus, the server computing systems and organized data structures thereof can be shared resources, where each cloud user is given a certain amount of dedicated use of the shared resources. Each cloud user's cloud-based site can be given a virtual amount of dedicated space and bandwidth in the cloud. Cloud applications can be different from other applications in their scalability, which can be achieved by cloning tasks onto multiple virtual machines at run-time to meet changing work demand. Load balancers distribute the work over the set of virtual machines. This process is transparent to the cloud user, who sees only a single access point.

Cloud-based remote access can be coded to utilize a protocol, such as Hypertext Transfer Protocol (“HTTP”), to engage in a request and response cycle with an application on a client computing system, such as a web-browser application resident on the client computing system. The cloud-based remote access can be accessed by a smartphone, a desktop computer, a tablet, or any other client computing systems, anytime and/or anywhere. The cloud-based remote access is coded to engage in 1) the request and response cycle from all web browser-based applications, 3) the request and response cycle from a dedicated on-line server, 4) the request and response cycle directly between a native application resident on a client device and the cloud-based remote access to another client computing system, and 5) combinations of these.

In an embodiment, the server computing system 204A can include a server engine, a web page management component or direct application component, a content management component, and a database management component. The server engine can perform basic processing and operating-system level tasks. The web page management component can handle creation, display, and routing of web pages or screens associated with receiving and providing digital content and digital advertisements, through a browser. Likewise, the direct application component may work with a client app resident on a user's device. Users (e.g., cloud users) can access one or more of the server computing systems by means of a Uniform Resource Locator (“URL”) associated therewith. The content management component can handle most of the functions in the embodiments described herein. The database management component can include storage and retrieval tasks with respect to the database, queries to the database, and storage of data.

In an embodiment, a server computing system can be configured to display information in a window, a web page, or the like. An application including any program modules, applications, services, processes, and other similar software executable when executed on, for example, the server computing system 204A, can cause the server computing system 204A to display windows and user interface screens in a portion of a display screen space.

Each application has a code scripted to perform the functions that the software component is coded to carry out such as presenting fields to take details of desired information. Algorithms, routines, and engines within, for example, the server computing system 204A can take the information from the presenting fields and put that information into an appropriate storage medium such as a database (e.g., database 206A). A comparison wizard can be scripted to refer to a database and make use of such data. The applications may be hosted on, for example, the server computing system 204A and served to the specific application or browser of, for example, the client computing system 202B. The applications then serve windows or pages that allow entry of details.

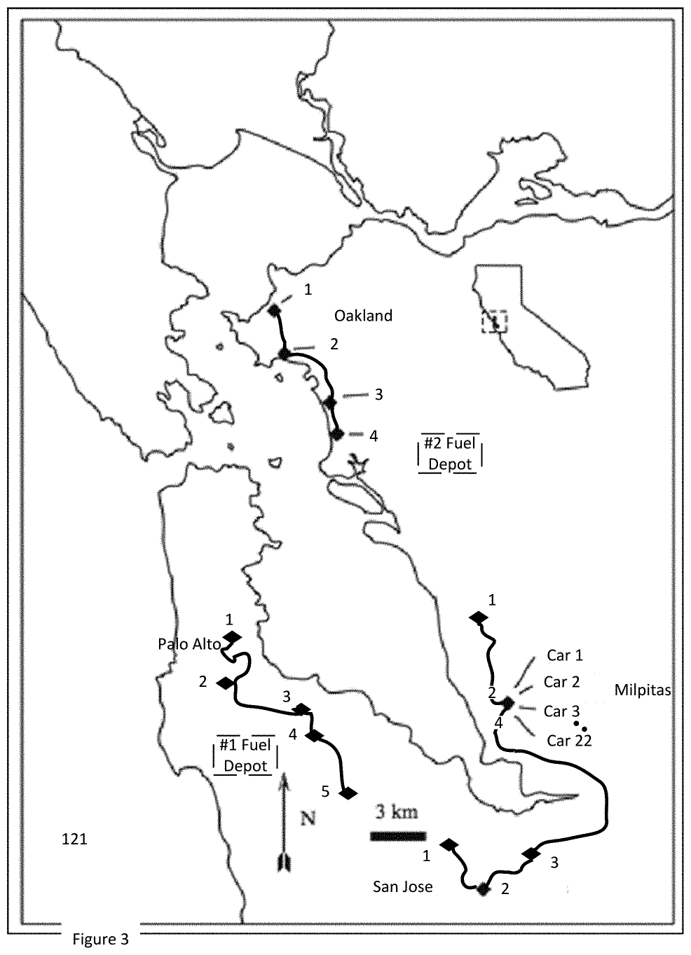

FIG. 3 illustrates a block diagram of an embodiment of an example refueling vehicle routing application performing vehicle routing that factors in constraints and parameters to utilize a combined amount of available assets located in multiple fuel depot yards to service a set of refueling routes for known vehicles in, at least, a first region (e.g., one or more regions). A version of the set of refueling routes utilizes the combined amount of available assets from multiple fuel depot yards that are optimized to 1) minimize an amount of refueling stops being i) late, ii) missed entirely, and iii) any combination of both, for their scheduled window of time for refueling, as well as 2) maximize a measure of how cost effective the version of the set of refueling routes still is in servicing a combined set of known target vehicles normally serviced by the available assets for refueling located in the multiple fuel depot yards. The input module cooperating with the refueling vehicle routing application 121 is configured to accept an asset sharing input in order to perform vehicle routing that factors in constraints to utilize a combined amount of available assets located in the multiple fuel depot yards to service the set of refueling routes. FIG. 3 illustrates multiple example refueling routes indicated by different shades of gray with their individual refueling stops within each refueling route indicated by a number such as 1, 3, 2, etc. A first fuel depot yard may be located by, for example, south of Palo Alto and have an example first refueling route with four refueling stops 1, 2, 3, 4, servicing a North and West region. A second fuel depot yard may be located in south of Oakland servicing refueling routes in the South and East regions. These neighboring/adjacent fuel depot yards can be selected to share assets and run refueling scenario simulations for the refueling application to generate a table of refueling routes and their results. For example, the single refueling stop in Milpitas with 22 target cars to be refilled may be serviced by a first refueling vehicle from the first fuel depot yard and a second refueling vehicle from the second fuel depot. The refueling vehicle routing application 121 is not restricted to assets, e.g., refueling vehicles, employees, fuel tanks and types, located within a single fuel depot yard when determining an optimum set of refueling routes for the region typically serviced by the fuel depot yard but can factor in a second fuel depot yard and/or adjacent region's assets when optimizing refueling routes.

A shift supervisor can view a version of the set of refueling routes based on combined assets from multiple fuel depot yards and coordinate potentially with another supervisor to implement the sharing of assets of the multiple fuel depot yards. If an agreement occurs, a version of a set of refueling routes using refueling assets can be selected and published to the cloud and then to individual drivers.

The user interface module is configured to cooperate with the refueling vehicle routing application 121 present, for example, the first stop of refueling route, a second stop of refueling route, a third stop of refueling route, etc., so that the user can visualize that set of refueling routes on a map. The set of refueling routes and road map is published to the cloud and conveyed to the handheld computing device of the driver and the cab of the refueling truck.

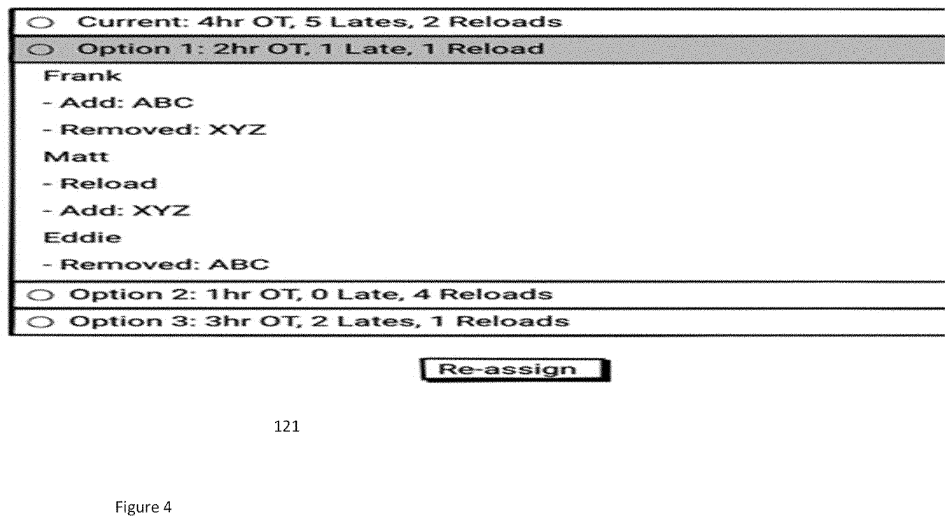

FIG. 4 illustrates a block diagram of an embodiment of an example user interface module configured to present the indications for the two or more versions of the set of refueling routes for the fleet of refueling vehicles to a user, such as a dispatcher, a shift supervisor, etc. on a display screen. The input module and user interface module cooperate to give an ability, such as buttons, icons, etc., for the user to select one of the presented versions of the set of refueling routes to be published on a cloud platform, via the communication module, as well as individually communicated via a communication interface to a handheld computing device of an assigned driver of a refueling vehicle what is their specific refueling route in the published version of the set of refueling routes.

The user interface module is coded to publish on the cloud and present on display screens multiple versions of the set of refueling routes to users, such as a shift supervisor, etc. The input module is configured to cooperate with the user interface module to give an ability for the user to select one of the versions of the set of refueling routes to be published on a cloud platform as well as individually communicated via an Application Programming Interface of a communication interface (e.g., email, instant messaging service, in-app pop up, etc.) to a handheld computing device of an assigned driver of a refueling vehicle what is their specific refueling route in the published version of the set of refueling routes.

For example, a current version of a set of refueling routes to service all of the target vehicles, generated by the refueling application, results in all of the fuel stops being satisfied with four hours of overtime needed, risking five windows of refueling being potentially late, and two refueling vehicle reloads needing to be coordinated while servicing the assigned set of refueling routes. In addition, the user interface module presents a second version of the set of refueling routes, option one, which has less overtime—e.g., two hours of overtime only, one window of refueling risking being potentially late, and merely one reload of a refueling vehicle with a tanker that has to be coordinated. In the second version, option 1, the user has made several manual changes to the current version of the set of refueling routes. For example, Frank, a first driver of a first refueling vehicle had refueling stops A, B, and C added to the refueling route and refueling stops X, Y, and Z removed from the refueling route assigned to Frank. Matt, a second driver of a second refueling vehicle added refueling stops X, Y, and Z to the refueling route serviced by Matt. Eddie, a third driver of a third refueling vehicle had refueling stops A, B, and C removed from his refueling route. The output results of this manually changed set of refueling routes are displayed.

A third version of the set of refueling generated by the refueling vehicle routing application 121 sums its results. For example, one hour of overtime to service all of the target vehicles, zero windows of servicing in risk of being potentially late, but needs four reloads of refueling vehicles with one or more fuel tankers that has to be coordinated during that shift of servicing the set of refueling routes. The fourth version of the set of refueling routes results in three hours of overtime, two windows of servicing times in risk of the servicing being late, and one fuel tanker reload needs to be coordinated. The user interface module presents all these options for, for example, the shift supervisor to review. The shift supervisor can then select one of these versions of the refueling routes in order to publish that chosen set of refueling routes. Note, the shift supervisor can also manually re-assign portions of a refueling route as discussed above. Thus, multiple solutions give multiple options to a supervisor who can then make the best educated decision in the end. The supervisor looks at a bunch of different versions of sets of refueling routes and chooses one to make their final decision and press the assign icon to confirm and make the set of refueling route assignments in that region.

After the assign button/icon is pushed then, that version of the set of refueling routes is published on the cloud as well as communicated via the communication interface individually to assigned drivers and refueling vehicles.

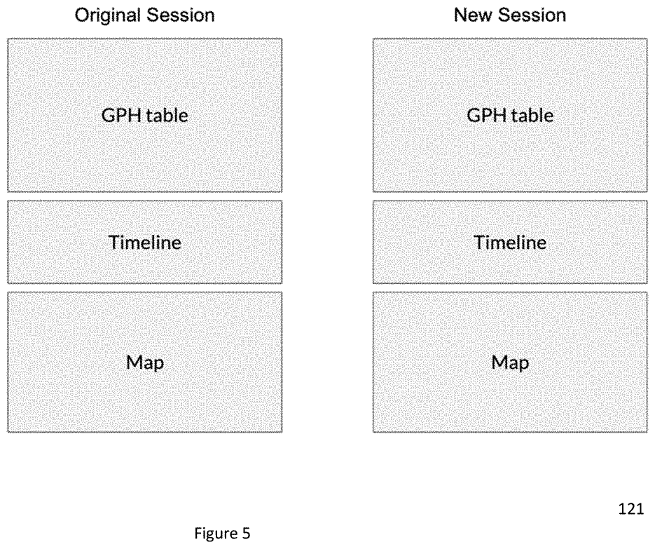

FIG. 5 illustrates a block diagram of an embodiment of an example output module configured to publish on the cloud as well as locally present on a display screen a version of the set of refueling routes to a user, such as a shift supervisor. The input module is configured to cooperate with the refueling vehicle routing application 121 and the user interface module to give an ability for the user to manually revise different aspects of the set of refueling routes including any of 1) one or more driving directions for refueling routes, 2) one or more refueling vehicles, 3) one or more drivers for the refueling vehicles, 4) one or more target vehicles to be refueled, and 5) any combination of these four. A first version of the set of refueling routes, which was generated by the refueling vehicle routing application 121, incorporate these manual changes. The refueling vehicle routing application 121 then triggers the refueling scenario simulator 127 to run a new refueling scenario with the manual changes made by the user, and then the output module is configured to present a comparison of a first version of the set of refueling routes generated by the refueling vehicle routing application 121 to a second version the set of refueling routes incorporating the manual changes on a same display screen.

This manual reroute support gives a capacity for a user to manually blend in machine analysis with user knowledge and experience to modify a refueling route generated solely by the refueling vehicle routing application 121 from an original set of constraints and parameters. The user can manually change one or more aspects of a refueling route and then the UI module allows a side by side comparison of the original set of refueling routes and the manually revised set of refueling routes along with output results of both versions of these sets of refueling routes.

The side by side comparison can show the first version of the set of refueling routes and its table of resulting gallons per hour, timeline of servicing windows, and map of refueling routes to a second/new version of the set of refueling routes and its resulting gallons per hour table, timeline of servicing windows, and map of refueling routes.

Thus, after reviewing the impacts of the changes on both versions of the sets of refueling routes the user can choose the version, for example, with the most favorable GPH, and a lowest amount of refueling stops in danger of being late or missed completely.

The user can adjust the routes according to, for example, the user's tribal knowledge. For example, the user can: override the demand gallons projected; override the duration forecasted; change the sequence of the refueling stops; remove and/or add orders for a refueling stop; lock a particular route/routes so that they cannot be changed; remove and/or add drivers to routes; remove and/or add tankers to routes; change a start time and/or starting location of a refueling vehicle; delay a tanker (keep the tanker in the current location for x amount of time to mimic traffic) or disable a tanker (tanker break down); add an additional tanker (most likely from the fuel depot yard location; change an expected refueling duration of a refueling stop, etc.

This again allows a user to compare a version of a set of refueling routes solely generated by information available to the refueling vehicle routing application 121 and a version of a set of refueling routes option that factored in the user's manual input.

Importantly, the shift supervisor can do these manual changes dynamically during the work shift to account for a traffic delay, the driver exceeded the delivery time, change drivers because one driver is more familiar with a particular geographical area in which a major portion of the refueling route will be carried out in, change drivers because one driver is more familiar with a particular piece of equipment for the refueling than another, choosing different roads and paths to take, than the suggested ones, etc. The dynamic changes will then be presented in a side by side comparison. The supervisor may then push the assign icon and publish the changes on the web as well as to the individual drivers and refueling vehicles affected. The refueling vehicle application also triggers the push notifications to the driver's handheld computing device and computer in the cab in the refueling vehicle.

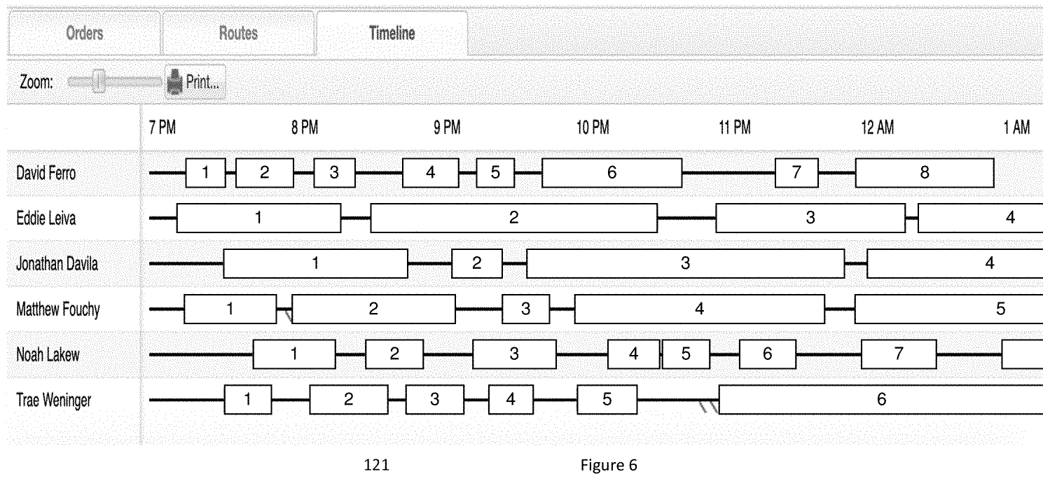

FIG. 6 illustrates a block diagram of an embodiment of an example set of refueling routes generated and presented by the user interface module to one or more users. The route view shows the driver and any other person viewing this view, the individual refueling route, the driver's workload, the driver's expected working time at that fuel stop, the driver's expected in and out time for each refueling stop, how much fuel the driver is expected dispense at a refueling stop, etc.

The user interface module presents a version of the set of refueling routes. Each refueling route shows each of its refueling stops within that refueling route, a person assigned to drive their refueling vehicle for that refueling route, windows of servicing duration when that refueling stop can occur and should be completed within that time span, and an overall timeline the refueling stops for each of the refueling routes. For example, driver Dave has eight refueling stops on his assigned refueling route. A first refueling stop on that refueling route starts a little bit after 7 PM and has about a 15 minute duration. The eighth and last refueling stop begins a little before 12 AM and its servicing window goes almost to 1 AM. In contrast, driver John has merely four refueling stops and his assigned refueling route, but these stops are much longer in duration indicating typically multiple target vehicles are serviced at a given refueling site.

Additionally, multiple routes can service a common refueling stop. The input module for the refueling vehicle routing application 121 can perform vehicle routing that factors in constraints and parameters to factor in splitting refueling gallon demand to service a refueling site containing multiple target vehicles over multiple refueling vehicles over multiple refueling routes. Each refueling route splitting the refueling gallon demand has been optimized to minimize an amount of fuel stops being i) late, and/or iii) missed entirely, as well as to maximize a measure of how cost effective the set of refueling routes while still servicing the single refueling site within its window of time for servicing, when the refueling demand (e.g., gallons) needs for all of the multiple target vehicles located approximate to the refueling site exceeds a capacity of a single refueling vehicle.

Next, as discussed, the refueling vehicle routing application 121 can cooperate with the communication interface and a refueling scenario simulator 127 to dynamically update and change the set of refueling routes and their assigned refueling stops throughout the day. Because we know this is this happens in real time, when the user notices a problem that the user wants to solve—e.g., traffic delay, vehicle breakdown, equipment failure, a new on-demand order for fuel delivery, etc.

Next, the refueling vehicle routing application 121 is configured to cooperate with a scheduling app used by shift supervisors to publish at least a week's worth of sets of refueling routes on a monitoring page of a scheduling app the supervisors use. The published week's worth of sets of refueling routes can be an all-encompassing view of everything. The week's worth of sets of refueling routes can also be individually communicated wirelessly via a communication interface to each handheld device corresponding to its assigned driver so they can get a rough idea of their specific refueling routes in the set of refueling routes for that week.

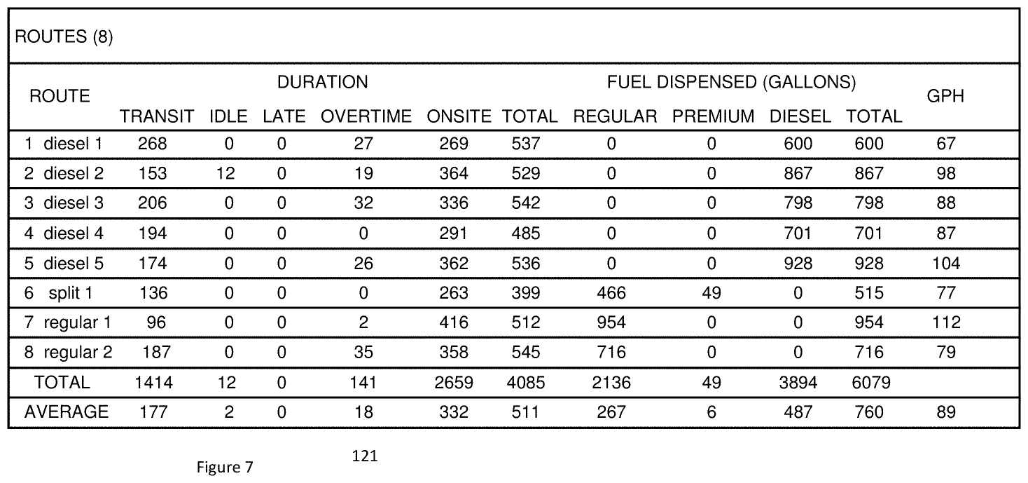

FIG. 7 illustrates a block diagram of an embodiment of an example output results, from the refueling vehicle routing application via the user interface module, of a set of refueling routes, in a table format, with the refueling routes' fuel types, transit time, an amount of service windows in risk of being serviced late, how much overtime will be required to service all of target vehicles in that refueling route, a total amount of gallons of fuel dispensed, each different type of fuel type being dispensed—regular gasoline, premium gasoline, diesel, etc., an anticipated total amount of the gallons dispensed on each refueling stop, and an effective gallons per hour distributed for that given refueling route.

A first example refueling route will be serviced by a refueling vehicle carrying diesel fuel. The refueling route will transit approximately 268 miles. This refueling route will have zero amount of times in danger of being idle and zero amount of times in danger of being late for the servicing window. The refueling route will require 27 minutes of overtime. The driver is estimated to be on site servicing the refueling stops for 269 minutes. The refueling vehicle for the refueling route is estimated to dispense approximately 600 gallons of diesel and the total amount of gallons of fuel dispensed will be 600 gallons. The refueling route is estimated to average 67 gallons per hour dispensed.

Note, an example sixth refueling route in this set of refueling routes show multiple types of fuel being dispensed by the single refueling vehicle; and thus, split between regular gasoline fuel (466 gallons) and premium gasoline fuel (49 gallons). This indicates that the refueling vehicle has two or more tanks, where each tank is filled with its own type of fuel. An example tanker as an available asset can haul a split of, for example, 500 gallons of gasoline in its first tank and 600 gallons of diesel in its second tank.

Thus, the refueling vehicle routing application 121 can evaluate and cooperate with the user interface module to visually show factors such as driving distance of each refueling route; total working hours of each route; a breakdown of onsite duration vs in transit duration vs idle duration; name and/or address of account at fuel stop; type of fuel and gallons dispensed for each refueling stop; a measure of total gallons dispensed for each refueling route; a number of service windows in danger of being late, missed, and/or early; an efficiency of gallons of fuel dispensed per hour; a number of tankers swaps and reloads; etc.

As discussed earlier, the refueling vehicle routing application 121 cooperating with the refueling scenario simulator 127 can run up to a million scenarios of different sets of refueling routes to refuel known target vehicles in light of an available set of assets, and up to millions of scenarios factoring X amount of different sets of refueling routes including possible roadways to refuel Y amount of known target vehicles and their variable parameters, in light of Z amount of currently available set of assets, in light of a cost effectiveness analysis and its variable parameters, in light of time of day and time in a work shift, in light of W amount of constraints placed on the refueling operations, in light of any other relevant factors, and then present multiple versions of these routes so a best choice can be selected. Note, humans cannot reasonably in a scalable way evaluate all of these factors and run up to millions of scenarios to determine an optimum set of refueling routes consistently on a daily basis, as well as then be dynamically evaluate and generate a new set of refueling routes to be optimized as changes occur within a work day.

As discussed earlier, the refueling vehicle routing application 121 can cooperate with a scheduling application used by shift supervisors to publish at least a week's worth of sets of refueling routes on a monitoring page of the scheduling application. The week's worth of sets of refueling routes is an all-encompassing view of everything, e.g., an entire set of refueling routes and refueling assets needed to satisfy the at least a week's worth of sets of refueling routes. The refueling vehicle routing application 121 can communicate the at least week's worth of sets of refueling routes, via the communication module and the communication interface, with the individual drivers of the refueling vehicles. This is communicated wirelessly via the communication interface to each handheld device corresponding to its assigned driver what is their specific refueling route in the set of refueling routes for that week.

The set of refueling routes for that week are filtered for that individual driver and communicated wirelessly to the hand held computing device associated with that individual driver and into a computer device located in a cab of the refueling vehicle assigned to that individual driver.

The refueling vehicle routing application 121 is configured to Solving split-demand vehicle routing problems using integer partitions. The refueling vehicle routing application 121 is configured to deliver gasoline and charge electric vehicle batteries via a mobile application. The refueling vehicle routing application 121 is configured to periodically solve large-scale vehicle routing problems with time windows (VRPTWs) on a regular basis. Customers use a mobile app to request gas for their vehicle and select a time window when their car will be available, and a refueling tanker truck visits them during that window. The process is fully contactless and was recently certified by the California Air Resources Board (CARB) as a new method of air pollution control that achieves the nation's strictest air quality standards.

There are many minor features that distinguish this system's operational problem from a garden-variety VRPTW, such as the use of multiple fuel types in the same tanker (regular, premium, diesel, and electric battery chargers), the substitutability of these fuel types (i.e. one can use premium gas to substitute for regular if necessary), and the fact that new requests arrive in a dynamic fashion throughout the day. The refueling vehicle routing application 121 is configured to feature splittability of demand. In order to address this, the refueling vehicle routing application 121 is configured to use an a priori splitting rule that transforms an instance of the split-demand VRP into an equivalent instance of the non-splittable VRP, which we will describe in the following section.

### Technical Approach

The concept of an a priori splitting rule (hereafter APSR). An APSR is simply the following process, applied to an instance of split-demand VRP (or, indeed, any resource allocation problem with splittable demand):

A priori splitting rule: Divide each demand node into multiple demand nodes at the same location, with the sum of the demands of these copies being equal to the original demand at the location. Then, solve an unsplittable CVRP on this larger problem.

When one employs an a priori splitting rule, a natural trade-off quickly presents itself: one obvious extreme is to take a node with demand of 10 units and divide it into 10 nodes with demand of one unit. The drawback to this process is that the number of nodes may be intractably large. At the other extreme, if we split a demand node is into a small (i.e. tractable) number of pieces, the number of possible ways to divide demand between the vehicles is limited. For example, if the refueling vehicle routing application 121 splits a node with demand of 10 into three nodes with demand 1, 3, and 6, but the true (unknown) optimal solution to the problem requires that that node be split between two vehicles that service 2 and 8 units of demand respectively, then the refueling vehicle routing application 121 is out of luck, and has prevented itself from finding the optimal solution.

The refueling vehicle routing application 121 can use a method from enumerative combinatorics called integer partitioning to devise a lossless APSR that results in the smallest possible computational overhead. Thus, the refueling vehicle routing application 121 is configured to split each demand node into the minimum number of pieces. By “lossless”, this means that the true (unknown) optimal solution is never lost, because any possible (integral) allocation of demand to vehicles remains feasible.

### A Lossless APSR

Recall that an integer partition of a positive integer ‘n’ is a way of writing ‘n’ as a sum of unordered positive integers. For example, a valid partition of ‘n’=1 is the set {4, 3, 2, 2}. A partition that consists of ‘k’ elements is called a k-partition. Typically in this problem context, it is sensible that ‘k’ should be the number of available refueling tankers, since that is the maximum possible amount of splitting that can occur. The system adopts the standard notational convention from combinatorics that μ├λif μλ is a partition of ‘n,’ that is, Σᵢμᵢ=n. We define the minimum-cardinality lossless APSR (MCLAPSR) problem as follows.

Minimum-cardinality lossless a priori splitting rule: Let n and k be integers, with k<n. A partition μ of n coalesces to a partition λ of n if it is possible to merge the terms of μ in a particular way so as to obtain λ: that is, there exists a decomposition of μ into disjoint subsets μS₁, . . . , μS_{|λ|} such that for each iΣ{1, . . . , |λ|λ}, μSi├λᵢ. If for all λ├n such that |λ|≥k, we have that μ can coalesce to λ, we say that μ coalexces to all k-partitions of n. The total of the (MCLAPSR) problem is to find the μ of minimum size such that μ coalesces to all k-partitions of n.

As a simple example, if n=7 and k=3, then the MCLAPSR is μ={3, 2, 1, 1}: there are a total of 8 partitions of 7 of size at most 3, and μ coalesces to all of them:

{7}={3+2+1+1} 1.

{6,1}={3+2+1,1} 2.

{5,2}={3+2,1+1} 3.

{4,3}={3+1,2+1} 4.

{5,1,1}={3+2,1,1} 5.

{4,2,1}={3+1,2,1} 6.

{3,3,1}={3,2+1,1} 7.

{3,2,2}={3,2,1+1} 8.

In this case it is obvious that μ must be minimal because it has cardinality 4, and we certainly cannot hope to coalesce to all partitions of size at most 3 with any fewer than that.

In solving the split-demand VRPTW, the system found and applied the following solution to MCLAPSR:

Theorem (a solution to MCLAPSR) Let n, k be integers, k≤n. Let μ be constructed as follows:

1. Let μ1=dn/ke; and

2. For i 6=1 let μi=d(n−Pj<i μj)/ke

Then μ is a minimum size partition that coalesces to all k-partitions of n.

Thus, the above result is applied to solve the split-demand VRP.

### Computational Results

The refueling vehicle routing application 121 implements this example solution to MCLAPSR and applies it to benchmark instances of the vehicle routing problem from TSPLIB. The refueling vehicle routing application 121 results in savings from using the splitting rule versus having splitting disabled.

In addition, the refueling vehicle routing application 121 is configured for real-time inventory reading. When the refueling vehicle routing application 121 is about to generate the routes for the shift, it can take the inputs directly from the tanker inventory through our onboard computer in the tanker to the cloud. Thus, allowing for a much more accurate route prediction given the tighter supply/demand match.

In addition, the refueling vehicle routing application 121 cooperates with a labor plan integration system. When the operator/dispatcher makes the route assignment, the system directly reads the drivers who are scheduled on that day, making it easy to call off extra labor if the system suggests.

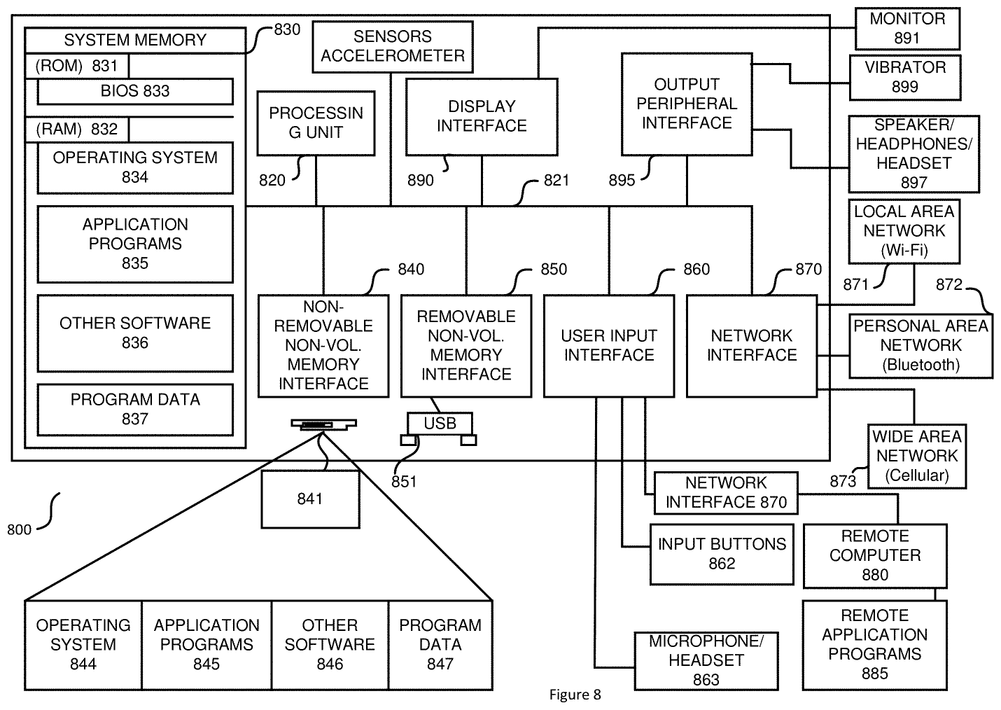

FIG. 8 illustrates a diagram of an embodiment of one or more computing devices that can be a part of the systems associated with the refueling vehicle routing system discussed herein. The computing device 800 may include one or more processors or processing units 820 to execute instructions, one or more memories 830-832 to store information, one or more data input components 860-863 to receive data input from a user of the computing device 800, one or more modules that include the management module, a network interface communication circuit 870 to establish a communication link to communicate with other computing devices external to the computing device, one or more sensors where an output from the sensors is used for sensing a specific triggering condition and then correspondingly generating one or more preprogrammed actions, a display screen 891 to display at least some of the information stored in the one or more memories 830-832 and other components. Note, portions of this system that are implemented in software 844, 845, 846 may be stored in the one or more memories 830-832 and are executed by the one or more processors 820.

The system memory 830 includes computer storage media in the form of volatile and/or nonvolatile memory such as read-only memory (ROM) 831 and random access memory (RAM) 832. These computing machine-readable media can be any available media that can be accessed by computing system 800. By way of example, and not limitation, computing machine-readable media use includes storage of information, such as computer-readable instructions, data structures, other executable software, or other data. Computer-storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by the computing device 800. Transitory media such as wireless channels are not included in the machine-readable media. Communication media typically embody computer readable instructions, data structures, other executable software, or other transport mechanism and includes any information delivery media.

The system further includes a basic input/output system 833 (BIOS) containing the basic routines that help to transfer information between elements within the computing system 800, such as during start-up, is typically stored in ROM 831. RAM 832 typically contains data and/or software that are immediately accessible to and/or presently being operated on by the processing unit 820. By way of example, and not limitation, the RAM 832 can include a portion of the operating system 834, application programs 835, other executable software 836, and program data 837.

The computing system 800 can also include other removable/non-removable volatile/nonvolatile computer storage media. By way of example only, the system has a solid-state memory 841. The solid-state memory 841 is typically connected to the system bus 821 through a non-removable memory interface such as interface 840, and USB drive 851 is typically connected to the system bus 821 by a removable memory interface, such as interface 850.

A user may enter commands and information into the computing system 800 through input devices such as a keyboard, touchscreen, or software or hardware input buttons 862, a microphone 863, a pointing device and/or scrolling input component, such as a mouse, trackball or touch pad. These and other input devices are often connected to the processing unit 820 through a user input interface 860 that is coupled to the system bus 821, but can be connected by other interface and bus structures, such as a parallel port, game port, or a universal serial bus (USB). A display monitor 891 or other type of display screen device is also connected to the system bus 821 via an interface, such as a display interface 890. In addition to the monitor 891, computing devices may also include other peripheral output devices such as speakers 897, a vibrator 899, and other output devices, which may be connected through an output peripheral interface 895.

The computing system 800 can operate in a networked environment using logical connections to one or more remote computers/client devices, such as a remote computing system 880. The remote computing system 880 can a personal computer, a mobile computing device, a server, a router, a network PC, a peer device or other common network node, and typically includes many or all of the elements described above relative to the computing system 800. The logical connections can include a personal area network (PAN) 872 (e.g., Bluetooth®), a local area network (LAN) 871 (e.g., Wi-Fi), and a wide area network (WAN) 873 (e.g., cellular network), but may also include other networks such as a personal area network (e.g., Bluetooth®). Such networking environments are commonplace in offices, enterprise-wide computer networks, intranets and the Internet. A browser application may be resonant on the computing device and stored in the memory.

When used in a LAN networking environment, the computing system 800 is connected to the LAN 871 through a network interface 870, which can be, for example, a Bluetooth® or Wi-Fi adapter. When used in a WAN networking environment (e.g., Internet), the computing system 800 typically includes some means for establishing communications over the WAN 873. With respect to mobile telecommunication technologies, for example, a radio interface, which can be internal or external, can be connected to the system bus 821 via the network interface 870, or other appropriate mechanism. In a networked environment, other software depicted relative to the computing system 800, or portions thereof, may be stored in the remote memory storage device. By way of example, and not limitation, the system has remote application programs 885 as residing on remote computing device 880. It will be appreciated that the network connections shown are examples and other means of establishing a communications link between the computing devices that may be used.

As discussed, the computing system 800 can include mobile devices with a processing unit 820, a memory (e.g., ROM 831, RAM 832, etc.), a built-in battery to power the computing device, an AC power input to charge the battery, a display screen, and a built-in Wi-Fi circuitry to wirelessly communicate with a remote computing device connected to network.

It should be noted that the present design can be carried out on a computing system such as that described with respect to shown herein. However, the present design can be carried out on a server, a computing device devoted to message handling, or on a distributed system in which different portions of the present design are carried out on different parts of the distributed computing system.

In some embodiments, software used to facilitate algorithms discussed herein can be embedded onto a non-transitory machine-readable medium. A machine-readable medium includes any mechanism that stores information in a form readable by a machine (e.g., a computer). For example, a non-transitory machine-readable medium can include read-only memory (ROM); random access memory (RAM); magnetic disk storage media; optical storage media; flash memory devices; Digital Versatile Disc (DVD's), EPROMs, EEPROMs, FLASH memory, magnetic or optical cards, or any type of media suitable for storing electronic instructions.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, Python, or other similar languages. Also, an algorithm can be implemented with lines of code in software, configured logic gates in software, or a combination of both. In an embodiment, the logic consists of electronic circuits that follow the rules of Boolean Logic, software that contain patterns of instructions, or any combination of both. Any portions of an algorithm implemented in software can be stored in an executable format in portion of a memory and is executed by one or more processors. A module can be implemented with electronic circuits, software stored in a memory and executed by processors, and combination of both electronic circuits and software cooperating with those electronic circuits in order to provide specific functionality as discussed herein.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

Many functions performed by electronic hardware components can be duplicated by software emulation. Thus, a software program written to accomplish those same functions can emulate the functionality of the hardware components in input-output circuitry. Thus, provided herein are one or more non-transitory machine-readable medium configured to store instructions and data that when executed by one or more processors on the computing device of the foregoing system, causes the computing device to perform the operations outlined as described herein.

References in the specification to “an embodiment,” “an example”, etc., indicate that the embodiment or example described may include a particular feature, structure, or characteristic, but every embodiment may not necessarily include the particular feature, structure, or characteristic. Such phrases can be not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

While the foregoing design and embodiments thereof have been provided in considerable detail, it is not the intention of the applicant(s) for the design and embodiments provided herein to be limiting. Additional adaptations and/or modifications are possible, and, in broader aspects, these adaptations and/or modifications are also encompassed. Accordingly, departures may be made from the foregoing design and embodiments without departing from the scope afforded by the following claims, which scope is only limited by the claims when appropriately construed.

What is claimed is:

1. A refueling vehicle routing system, comprising:
one or more servers and databases,
one or more memories to store data and instructions,
one or more processors to execute the instructions,
a communication module configured to receive and send communications over a cloud network and then to multiple refueling vehicles wirelessly connected to the cloud network,
a refueling vehicle routing application configured to compute a set of fuel delivery routes for a fleet of two or more refueling vehicles for multiple different target vehicles to be serviced via cooperating with a refueling scenario simulator, where the refueling scenario simulator is configured to run at least a hundred scenarios of different sets of refueling routes to refuel known target vehicles in light of an available set of assets, and then the refueling vehicle routing application is configured to supply results of how two or more versions of the set of refueling routes for the fleet of refueling vehicles are going 1) to satisfy anticipated refueling needs for all known target vehicles; 2) to indicate any refueling stops that are likely to be, at least one of, i) late, ii) early, iii) missed entirely, and iv) any of these three, for a window of time in which that refueling stop should be serviced; as well as 3) to show a measure of how cost effective each of the two or more versions of the set of refueling routes is at the satisfying of the anticipated refueling needs for all of the known target vehicles; and
an input module configured to take in a plurality of constraints and parameters as factors, for the refueling vehicle routing application to assist in producing the results of how two or more versions of the set of refueling routes for the fleet of refueling vehicles are going 1) to satisfy the anticipated refueling needs for all of the known target vehicles; 2) to indicate the refueling stops that are likely to be, at least one of, i) late, ii) early, iii) missed entirely, and iv) any of these three, for the window of time in which that refueling stop should be serviced; as well as 3) to show the measure of how cost effective each of the two or more versions of the set of refueling routes is at the satisfying of the anticipated refueling needs for all of the known target vehicles.

2. The refueling vehicle routing system of claim 1, where the refueling vehicle routing application and a user interface module are configured to cooperate to present the results for the two or more versions of the set of refueling routes for the fleet of refueling vehicles to a first user on a display screen, where the input module and the user interface module cooperate to give an ability for the first user to select one of the presented versions of the set of refueling routes to be to published on a cloud platform, via the communication module, as well as to be individually communicated via a communication interface to a handheld computing device of an assigned driver of a refueling vehicle to convey what is their specific refueling route in the published version of the set of refueling routes.

3. The refueling vehicle routing system of claim 2, where the refueling vehicle routing application is further configured to cooperate with the communication interface and the refueling scenario simulator to be capable of updating the set of refueling routes throughout a day dynamically, where the user interface module is configured to present selectable options of choosing either 1) a first version of new refueling routes selected in order to minimize an impact on a smallest amount of drivers and their corresponding refueling route as possible or 2) a second version of new refueling routes selected to be a most efficient and cost effective for the entire fleet of refueling vehicles regardless of how many drivers' refueling routes need to be changed after those drivers have already started servicing the refueling route assigned to them at the beginning of their driving shift, and then send the update via the communication interface to the handheld computing device of each affected driver and their refueling vehicle.

4. The refueling vehicle routing system of claim 1, the refueling vehicle routing application is configured to perform vehicle routing that factors in parameters consisting two or more of the following:
i) aspects of a refueling vehicle beyond just a capacity of its fuel tank and its fuel type;
ii) splitting an amount of refueling demand of a refueling site containing multiple target vehicles over multiple refueling vehicles and over multiple refueling routes in the set of refueling routes, when an amount of refueling gallons for all of the multiple target vehicles located approximate to and within the refueling site exceeds a capacity of a single refueling vehicle;
iii) presenting one or more delivery windows that are likely in danger of being arrived at too early to be within the window of time in which that refueling stop should be serviced, in danger of being arrived too late to be within the window of time in which that refueling stop should be serviced, and/or in danger of being completely missed because one or more target vehicles will likely be gone by a time of the window of time in which that refueling stop should be serviced ends; and
to factor a combined amount of available assets located in multiple fuel depot yards to service a set of refueling routes for known vehicles in, at least, a first region.

5. The refueling vehicle routing system of claim 4, where the input module is configured to cooperate with the refueling vehicle routing application to supply aspects of the refueling vehicle beyond just the capacity of its fuel tank and its fuel type for the refueling vehicle routing application to perform the vehicle routing, where additional parameters of the refueling vehicle including
i) whether a first refueling vehicle has an ability to haul multiple types of fuels because the refueling vehicle has multiple tanks to hold the multiple types of fuels,
ii) whether the first refueling vehicle has a pumping system to load and/or off-load liquids with a different flow rate support than other refueling vehicles in the fleet; and
what is an actual current level of fuel remaining in one or more tanks of the first refueling vehicle as indicated by a level sensor in that tank and then communicated by a wireless communication module in the refueling vehicle over a network to the refueling vehicle routing application via the communication module.

6. The refueling vehicle routing system of claim 4, where the input module is configured to cooperate with the refueling vehicle routing application to perform vehicle routing that factors in a constraint for splitting refueling gallon demand to service the refueling site containing multiple target vehicles over multiple refueling vehicles over multiple refueling routes, where each refueling route splitting the refueling gallon demand has been optimized to 1) minimize an amount of fuel stops being i) late, and/or iii) missed entirely, as well as 2) to maximize an overall measure of cost effectiveness for all of the refueling routes in the set of refueling routes while still servicing the first refueling site within its window of time for servicing, when the amount of refueling demand needs for all of the multiple target vehicles located approximate to and within the refueling site exceeds the capacity of the first refueling vehicle.

7. The refueling vehicle routing system of claim 4, where the input module with the refueling vehicle routing application is configured to accept an asset sharing input parameter to perform vehicle routing to utilize a combined amount of available assets located in multiple fuel depot yards to service the set of refueling routes for known vehicles in, at least, the first region, where a first version of the set of refueling routes utilizing the combined amount of available assets from multiple fuel depot yards has been optimized to 1) minimize an amount of refueling stops being i) late, ii) missed entirely, and iii) any combination of both, for their scheduled window of time for refueling, as well as 2) maximize the measure of how cost effective the first version of the set of refueling routes still is in servicing a combined set of known target vehicles, normally serviced by the available assets for refueling, located in the multiple fuel depot yards.

8. The refueling vehicle routing system of claim 1, where the refueling vehicle routing application and a user interface module are configured to cooperate to present a first version of the set of refueling routes to a first user on a display screen, where the input module is configured to give an ability for the first user to manually revise different aspects of the first version of the set of refueling routes including any of 1) one or more driving directions for refueling routes, 2) one or more refueling vehicles assigned to service a refueling route, 3) one or more drivers for the refueling vehicles, 4) one or more target vehicles to be refueled, and 5) any combination of these four, where the first version of the set of refueling routes is generated by the refueling vehicle routing application, and the refueling vehicle routing application is then configured to trigger the refueling scenario simulator to run a new refueling scenario with the manual changes made by the first user, where the user interface module is configured to cooperate with the refueling vehicle routing application to present a comparison of the first version of the set of refueling routes generated by the refueling vehicle routing application to a second version the set of refueling routes incorporating the manual changes on a same display screen.

9. The refueling vehicle routing system of claim 1, where the refueling vehicle routing application is configured to cooperate with a scheduling app to publish at least a week's worth of sets of refueling routes on a scheduling app, which is an all-encompassing view of an entire set of refueling routes and refueling assets needed to satisfy the at least a week's worth of sets of refueling routes.

10. A non-transitory computer-readable medium including executable instructions that, when executed with one or more processors, cause an explanation engine to perform operations as follows, comprising:
causing a communication module to receive and send communications over a cloud network and then to multiple refueling vehicles wirelessly connected to the cloud network,
causing a refueling vehicle routing application to compute a set of fuel delivery routes for a fleet of two or more refueling vehicles for multiple different target vehicles to be serviced via cooperating with a refueling scenario simulator, where the refueling scenario simulator is configured to run at least a hundred scenarios of different sets of refueling routes to refuel known target vehicles in light of an available set of assets, and then the refueling vehicle routing application is configured to supply results of how two or more versions of the set of refueling routes for the fleet of refueling vehicles are going 1) to satisfy anticipated refueling needs for all known target vehicles; 2) to indicate any refueling stops that are likely to be, at least one of, i) late, ii) early, iii) missed entirely, and iv) any of these three, for a window of time in which that refueling stop should be serviced; as well as 3) to show a measure of how cost effective each of the two or more versions of the set of refueling routes is at the satisfying of the anticipated refueling needs for all of the known target vehicles; and
causing an input module to take in plurality of constraints and parameters as factors, for the refueling vehicle routing application to assist in producing the results of how two or more versions of the set of refueling routes for the fleet of refueling vehicles are going 1) to satisfy the anticipated refueling needs for all of the known target vehicles; 2) to indicate the refueling stops that are likely to be, at least one of, i) late, ii) early, iii) missed entirely, and iv) any of these three, for the window of time in which that refueling stop should be serviced; as well as 3) to show the measure of how cost effective each of the two or more versions of the set of refueling routes is at the satisfying of the anticipated refueling needs for all of the known target vehicles.

11. The computer-readable medium of claim 10, containing further executable instructions to perform further operations, comprising:
causing the refueling vehicle routing application and a user interface module to cooperate to present the results for the two or more versions of the set of refueling routes for the fleet of refueling vehicles to a first user on a display screen, where the input module and the user interface module cooperate to give an ability for the first user to select one of the presented versions of the set of refueling routes to be to published on a cloud platform, via the communication module, as well as to be individually communicated via a communication interface to a handheld computing device of an assigned driver of a refueling vehicle to convey what is their specific refueling route in the published version of the set of refueling routes.

12. A method for a refueling vehicle routing system, comprising:
configuring a communication module to receive and send communications over a cloud network and then to multiple refueling vehicles wirelessly connected to the cloud network,
configuring a refueling vehicle routing application to compute a set of fuel delivery routes for a fleet of two or more refueling vehicles for multiple different target vehicles to be serviced via cooperating with a refueling scenario simulator, where the refueling scenario simulator is configured to run at least a hundred scenarios of different sets of refueling routes to refuel known target vehicles in light of an available set of assets, and then the refueling vehicle routing application is configured to supply results of how two or more versions of the set of refueling routes for the fleet of refueling vehicles are going 1) to satisfy anticipated refueling needs for all known target vehicles; 2) to indicate any refueling stops that are likely to be, at least one of, i) late, ii) early, iii) missed entirely, and iv) any of these three, for a window of time in which that refueling stop should be serviced; as well as 3) to show a measure of how cost effective each of the two or more versions of the set of refueling routes is at the satisfying of the anticipated refueling needs for all of the known target vehicles; and
configuring an input module to take in a plurality of constraints and parameters as factors, for the refueling vehicle routing application to assist in producing the results of how two or more versions of the set of refueling routes for the fleet of refueling vehicles are going 1) to satisfy the anticipated refueling needs for all of the known target vehicles; 2) to indicate the refueling stops that are likely to be, at least one of, i) late, ii) early, iii) missed entirely, and iv) any of these three, for the window of time in which that refueling stop should be serviced; as well as 3) to show the measure of how cost effective each of the two or more versions of the set of refueling routes is at the satisfying of the anticipated refueling needs for all of the known target vehicles.

13. The method for the refueling vehicle routing system of claim 12, further comprising:
configuring the refueling vehicle routing application and a user interface module to cooperate to present the results for the two or more versions of the set of refueling routes for the fleet of refueling vehicles to a first user on a display screen, where the input module and the user interface module cooperate to give an ability for the first user to select one of the presented versions of the set of refueling routes to be to published on a cloud platform, via the communication module, as well as to be individually communicated via a communication interface to a handheld computing device of an assigned driver of a refueling vehicle to convey what is their specific refueling route in the published version of the set of refueling routes.

14. The method for the refueling vehicle routing system of claim 13, further comprising:
configuring the refueling vehicle routing application to cooperate with the communication interface and the refueling scenario simulator to be capable of updating the set of refueling routes throughout a day dynamically, where the user interface module is configured to present selectable options of choosing either 1) a first version of new refueling routes selected in order to minimize an impact on a smallest amount of drivers and their corresponding refueling route as possible or 2) a second version of new refueling routes selected to be a most efficient and cost effective for the entire fleet of refueling vehicles regardless of how many drivers' refueling routes need to be changed after those drivers have already started servicing the refueling route assigned to them at the beginning of their driving shift, and then send the update via the communication interface to the handheld computing device of each affected driver and their refueling vehicle.

15. The method for the refueling vehicle routing system of claim 12, further comprising:
configuring the refueling vehicle routing application to perform vehicle routing that factors in parameters consisting two or more of the following:
i) aspects of a refueling vehicle beyond just a capacity of its fuel tank and its fuel type;
ii) splitting an amount of refueling demand of a refueling site containing multiple target vehicles over multiple refueling vehicles and over multiple refueling routes in the set of refueling routes, when an amount of refueling gallons for all of the multiple target vehicles located approximate to and within the refueling site exceeds a capacity of a single refueling vehicle;
iii) presenting one or more delivery windows that are likely in danger of being arrived at too early to be within the window of time in which that refueling stop should be serviced, in danger of being arrived too late to be within the window of time in which that refueling stop should be serviced, and/or in danger of being completely missed because one or more target vehicles will likely be gone by a time of the window of time in which that refueling stop should be serviced ends; and
to factor a combined amount of available assets located in multiple fuel depot yards to service a set of refueling routes for known vehicles in, at least, a first region.

16. The method for the refueling vehicle routing system of claim 15, further comprising:
configuring the input module to cooperate with the refueling vehicle routing application to supply aspects of the refueling vehicle beyond just the capacity of its fuel tank and its fuel type for the refueling vehicle routing application to perform the vehicle routing, where additional parameters of the refueling vehicle including
i) whether a first refueling vehicle has an ability to haul multiple types of fuels because the refueling vehicle has multiple tanks to hold the multiple types of fuels,
ii) whether the first refueling vehicle has a pumping system to load and/or off-load liquids with a different flow rate support than other refueling vehicles in the fleet; and
what is an actual current level of fuel remaining in one or more tanks of the first refueling vehicle as indicated by a level sensor in that tank and then communicated by a wireless communication module in the refueling vehicle over a network to the refueling vehicle routing application via the communication module.

17. The method for the refueling vehicle routing system of claim 15, further comprising:
configuring the input module to cooperate with the refueling vehicle routing application to perform vehicle routing that factors in a constraint for splitting refueling gallon demand to service the refueling site containing multiple target vehicles over multiple refueling vehicles over multiple refueling routes, where each refueling route splitting the refueling gallon demand has been optimized to 1) minimize an amount of fuel stops being i) late, and/or iii) missed entirely, as well as 2) to maximize an overall measure of cost effectiveness for all of the refueling routes in the set of refueling routes while still servicing the first refueling site within its window of time for servicing, when the amount of refueling demand needs for all of the multiple target vehicles located approximate to and within the refueling site exceeds the capacity of the first refueling vehicle.

18. The method for the refueling vehicle routing system of claim 15, further comprising:
configuring the input module for the refueling vehicle routing application to accept an asset sharing input parameter to perform vehicle routing to utilize a combined amount of available assets located in multiple fuel depot yards to service the set of refueling routes for known vehicles in, at least, the first region, where a first version of the set of refueling routes utilizing the combined amount of available assets from multiple fuel depot yards has been optimized to 1) minimize an amount of refueling stops being i) late, ii) missed entirely, and iii) any combination of both, for their scheduled window of time for refueling, as well as 2) maximize the measure of how cost effective the first version of the set of refueling routes still is in servicing a combined set of known target vehicles, normally serviced by the available assets for refueling, located in the multiple fuel depot yards.

19. The method for the refueling vehicle routing system of claim 12, further comprising:
configuring the refueling vehicle routing application and a user interface module to cooperate to present a first version of the set of refueling routes to a first user on a display screen, where the input module is configured to give an ability for the first user to manually revise different aspects of the first version of the set of refueling routes including any of 1) one or more driving directions for refueling routes, 2) one or more refueling vehicles assigned to service a refueling route, 3) one or more drivers for the refueling vehicles, 4) one or more target vehicles to be refueled, and 5) any combination of these four, where the first version of the set of refueling routes is generated by the refueling vehicle routing application, and the refueling vehicle routing application is then configured to trigger the refueling scenario simulator to run a new refueling scenario with the manual changes made by the first user, where the user interface module is configured to cooperate with the refueling vehicle routing application to present a comparison of the first version of the set of refueling routes generated by the refueling vehicle routing application to a second version the set of refueling routes incorporating the manual changes on a same display screen.

20. The method for the refueling vehicle routing system of claim 12, further comprising:
configuring the refueling vehicle routing application to cooperate with a scheduling app to publish at least a week's worth of sets of refueling routes on a scheduling app, which is an all-encompassing view of an entire set of refueling routes and refueling assets needed to satisfy the at least a week's worth of sets of refueling routes.
